(19) United States
(12) Patent Application Publication
(10) Pub. No.: US 2020/0065395 A1
(43) Pub. Date: Feb. 27, 2020

(54) EFFICIENT LEAF INVALIDATION FOR QUERY EXECUTION

(71) Applicant: eBay Inc., San Jose, CA (US)

(72) Inventors: Alberto Ordonez Pereira, Santa Clara, CA (US); Roberto Daniel Konow Krause, Los Gatos, CA (US)

(21) Appl. No.: 16/109,281

(22) Filed: Aug. 22, 2018

(51) Int. Cl. G06F 17/30

(52) U.S. Cl. CPC G06F 17/3053; G06F 17/30324; G06F 17/30327

(57) ABSTRACT

One or more factors of a query and one or more search result candidates are identified. A plurality of decision trees are associated, via a data structure, with one or more leaf invalidation pairs for at least a first value of the one or more factors. The one or more search result candidates are scored based at least in part on the associating of the plurality of decision trees with one or more leaf invalidation pairs for at least the first value of the one or more factors within the data structure.

### BACKGROUND

Users typically input one or more search terms as a query within a field of a search engine in order to receive information particular to the query. For example, after launching a web browser, a user can input search engine terms corresponding to a particular resource or topic (e.g., documents, links, web pages, item listings, etc.), and one or more servers hosting the search engine logic can obtain data from various remote data sources and cause a web page to display various ranked results associated with the particular resource or topic. The user may then select one or more of the various ranked result identifiers.

Search engine software typically matches terms in the query to terms as found within result candidate data sets and rank the results for display based on the matching. For example, some technical solutions employ term frequency-inverse document frequency (TF-IDF) algorithms. TF-IDF algorithms include numerical statistics that infer how important a query word or term is to a data set. “Term frequency” illustrates how frequently a term of a query occurs within a data set (e.g., a digital document, a blog post, a database, etc.), which is then divided by the data set length (i.e., the total quantity of terms in the data set). “Inverse document frequency” infers how important a term is by reducing the weights of frequently used or generic terms, such as “the” and “of,” which may have a high count in a data set but have little importance for relevancy of a query. Accordingly, a query may include the terms “The different models of product X.” These technologies may then rank a data set the highest because it includes the words “product X” with the highest frequency compared to other data sets.

### BRIEF SUMMARY

The existing search engine software technologies are static and/or are costly in terms of CPU, memory, and/or throughput. For example, TF-IDF-based technologies and other technologies, such as “Best Matching (BM) 25” search engines, statically analyze the terms of the query itself against several data sets regardless of any learning techniques to help return more relevant query results. While other search engine software technologies, such as existing search engines that use Gradient Descent Boost Trees (GDBT), employ machine learning techniques, these technologies are costly. For example, particular decision tree structures, such as GDBTs, include a forest of decision trees, where each tree holds Boolean values (e.g., TRUE, FALSE) in the internal nodes of the decision tree. Typically, when a query is issued and received, various factors are obtained from the query and document. These factors and values are located in the root and branch nodes of the decision trees. Each of the relevant decision trees are traversed based on whether a factor value meets a condition (e.g., price <$25) in a node and the corresponding Boolean value (e.g., TRUE). Each of these decision trees are traversed, starting at the root node, then the branch nodes, and ultimately arrive at a leaf node of several leaf nodes, which holds the score for use in sorting search results. The cost problem is that there are typically several trees that are often very large, which means that these structures take up a lot of memory storage space as well as take a large quantity of time to process in terms of CPU and network latency because each node of the tree has to be traversed. Further, CPU execution time is often slow because of branch mispredictions. For typical CPU operations, when a next line of code to be executed depends on a result of a condition (e.g., an IF/ELSE clause), a typical optimization the CPU performs is to guess which line of code will be executed next. If the CPU guess was right, the execution of the query is continued without penalty. However, if the guess is wrong, code needs to be removed from the CPU and a correct portion of code needs to be loaded into the CPU pipeline. This causes a CPU penalty in terms of cycles lost. Because GDBTs include so many trees and very large trees (thereby increasing the quantity of conditional code execution guesses), the likelihood of GDBT branch misprediction is much greater.

Other existing search engine technologies utilize techniques, such as IF-THEN-ELSE implementations. However, these technologies require modifying/updating the source code of the search engine every time a new model is added. These technologies are also costly in terms of CPU branch mispredictions as described above. Other existing search engine technologies, such as QUICKSCORER, are also limited to trees with at most 64 leaves. This technology stores, for each node of each tree, a 64-bit length bit sequence, which uses a machine word. Accordingly, if there are n number of leaves, 0(n2) bits will be needed, thereby decreasing the chances that this will fit in cache or will take up large quantities of memory. Further, this technology stores a score or value associated with a factor in each cell of a data structure. This is redundant and accordingly adds more overhead to the data structure.

Embodiments of the present disclosure improve the existing search engine software technologies and computing devices by implementing new functions or functionalities that are less costly in terms of CPU, memory, network latency, and/or throughput. For instance, some embodiments improve existing technologies that utilize typical GDBTs because the system does not have to traverse every node of every tree, thereby decreasing CPU execution time. For the same reason, branch mispredictions are reduced or eliminated since conditional code execution guesses do not occur because each node is not traversed. Some embodiments of the present disclosure improve the existing technologies by including a data structure and/or bitmap that associates each tree with leaf invalidation pairs for factor-value pairs, which is described in more detail below. Accordingly, instead of traversing each node of each tree, the system can look up leaf invalidation pairs for each decision tree in a particular data structure and/or bitmap, which reduces I/O, latency, branch mispredictions, etc. Moreover, some embodiments improve existing technologies because there is no need to require a modification/update of source code of the search engine every time a new model is added, as IF-THEN-ELSE technologies do. Further, some embodiments improve existing technologies, such as QUICKSCORER, because the system can handle any quantity of leaves in a tree (as opposed to 64 only). Some embodiments improve these technologies by including a data structure (or set of data structures) that reduce the total space taken up in memory, as these particular embodiments may need only 0(n log 2 n) bits (e.g., as opposed to 0(n2) bits needed to represent nodes that have been invalidated in QUICKSCORER). Accordingly, there is a higher probability that this novel data structure will fit in cache, which improves throughput, CPU execution. Further, there is reduced redundancy compared to technologies by adding less overhead to data structures and taking up less memory. For example, some embodiments generate and use a more compact/efficient approach to store which tree's leaves are invalidated by associating each tree with leaf invalidation pairs, using less bits (e.g., some or each component of FIG. 4 and/or FIG. 2A). Further, some embodiments improve existing search engine technologies by using lists of factor-value pairs, as opposed to only using lists of factors, which reduces the size of a data structure while improving memory access and CPU time.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

The present technology is described in detail below with reference to the attached drawing figures, wherein:

FIG. 1 is a block diagram of an illustrative system architecture in which some embodiments of the present technology may be employed, according to particular embodiments.

FIG. 2A is a schematic diagram of a bitmap that is implemented by aspects of the present disclosure, according to some embodiments.

FIG. 2B is a schematic diagram of a decision tree in which aspects of the present disclosure are implemented, according to particular embodiments.

FIG. 3 is a schematic diagram of a forest of decision trees in which aspects of the present disclosure are implemented, according to some embodiments.

FIG. 4 is a block diagram of a data structure in which aspects of the present disclosure are implemented, according to some embodiments.

FIG. 5 is a schematic diagram of one or more data structures in which aspects of the present disclosure are implemented, according to particular embodiments.

FIG. 6 is a flow diagram of an example process for scoring one or more search result candidates based on a first k position bit in a bitmap, according to particular embodiments.

FIG. 7 is a flow diagram of an example process for providing search results for a user request, according to some embodiments.

FIG. 8 is a block diagram of a computing environment in which aspects of the present disclosure are implemented within, according to particular embodiments.

FIG. 9 is a block diagram of a computing device in which aspects of the present disclosure are implemented within, according to various embodiments.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

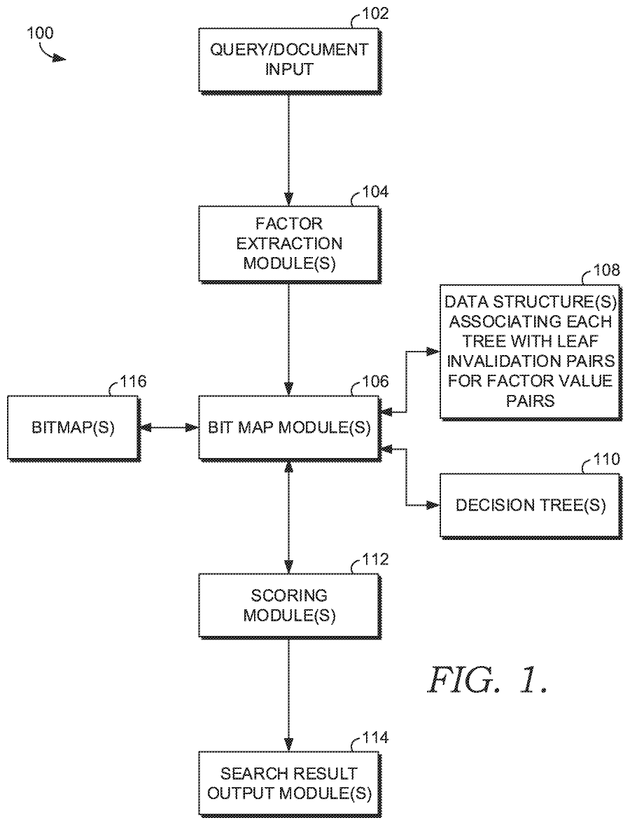

FIG. 1 is a block diagram of an illustrative search engine system architecture 100 in which some embodiments of the present technology may be employed. Although the system 100 is illustrated as including specific component types associated with a particular quantity, it is understood that alternatively or additionally other component types may exist at any particular quantity. In some embodiments, one or more modules may also be combined. For example, the scoring module(s) 112 and the search result output module(s) 114 can be included in the same module. It is also understood that each component or module can be located on the same or different host computing devices. For example, in some embodiments, some or each of the components within the search engine system 100 are distributed across a cloud computing system. In some embodiments, the system 100 illustrates executable program code such that all of the illustrated modules and data structures are linked in preparation to be executed at run-time of a query.

At 102, the system 100 receives a query and/or document (e.g., a search result candidate) input. For example, in some embodiments, the query input and/or document 102 is received “offline” or outside of a run-time situation. Accordingly, the query may be issued outside of a user session by training modules or administrative users. Alternatively or additionally, in some embodiments, the query/document input 102 is data that is received at run-time or as part of a user session. Accordingly, a user may open a portal and input a query string within a search engine field. A “portal” as described herein in some embodiments includes a feature to prompt authentication and/or authorization information (e.g., a username and/or passphrase) such that only particular users (e.g., a corporate group entity) are allowed access to information. A portal can also include user member settings and/or permissions and interactive functionality with other user members of the portal, such as instant chat. In some embodiments, a portal is not necessary to receive the query, but rather a query can be received via a public search engine (e.g., GOOGLE by ALPHABET Inc. of Mountain View, Calif.) or website such that no login is required (e.g., authentication and/or authorization information) and anyone can view the information. In response to a user inputting a query, such as a string of characters (e.g., “cheap jewelry”), the query is transmitted to the system, such as the one or more factor extraction modules of FIG. 1.

The one or more factor extraction modules 104 identify and/or extract one or more factors and/or factor values from the query of the query input 102 and/or documents. A “factor” as illustrated herein describes one or more attribute values of one or more terms of the query and/or search result candidate data sets. For example, factors can be or include the factors of: listing price of an item for sale (e.g., average price that users have selected for a query), time (e.g., when a query was issued), subject category of a query (e.g., sunglasses, sports, news, video, etc.), brand, color, etc. In some embodiments, factors are identified by running one or more query/search result candidate terms through a learning model, such as a word embedding vector model (e.g., WORD2VEC). For example, the term “red sunglasses” can be run through a word embedding vector model category matrix and the term “red” may be closest to the category “color” in vector space and so “color” may be determined to be the factor and “red” is the value of the “color” factor.

In some embodiments, alternatively or additionally, techniques such as natural language processing (NLP) are used to identify factors. NLP is a technique configured to analyze semantic and syntactic content of unstructured/semi-structured data of a set of data. In certain embodiments, the natural language processing technique may be a software tool, widget, or other program configured to determine meaning behind the unstructured data. More particularly, the natural language processing technique can be configured to parse a semantic feature and a syntactic feature of the unstructured data. The natural language processing technique can be configured to recognize keywords, contextual information, and metadata tags associated with one or more portions of the set of data. In certain embodiments, the natural language processing technique can be configured to analyze summary information, keywords, figure captions, or text descriptions included in the set of data, and use syntactic and semantic elements present in this information to identify information used for dynamic user interfaces. The syntactic and semantic elements can include information such as word frequency, word meanings, text font, italics, hyperlinks, proper names, noun phrases, parts-of-speech, or the context of surrounding words. Other syntactic and semantic elements are also possible. In an illustrative example, for the phrase “big apple” in a query, “city” may be chosen as a factor (with “New York City” as a value), as opposed to “fruit” because of the semantic meaning of “big apple.”

In some embodiments, alternatively or additionally, one or more terms of the query/search result candidate data sets are tagged (e.g., with metadata) and are matched against a set of data for factor determination. For example, a user may issue a first query. When the system 100 receives the first query, it may tag and store the first query with timestamp metadata indicating when the first query was received, such that the time stamp value can be associated with a “time” factor. In another example, the system may associate the query “necklaces 25 dollars or less” with at least a factor of “price” because a set of rules may indicate that if the term “dollars,” “less,” is within a query, then the factor “price” is included, and the integer value within the query corresponds to the factor value (e.g., 25).

The one or more bit map modules 106 set a set of bits in a 116 bit map (e.g., a bit array) to indicate whether one or more leaves of one or more decision trees 110 (e.g., a GBDT tree) are reachable (e.g., set to TRUE/1) and/or non-reachable (e.g., set to FALSE/0). The setting of the bits can be based on obtaining data from the data structure 108. Bitmaps are used herein to identify the first k position bit that indicates the first reachable leaf node or the leaf node that is used for scoring search result candidates. The one or more bitmaps are described in more detail below. The one or more bitmap modules 106 may alternatively or additionally associate each decision tree with leaf invalidation pairs for factor-value pairs via the data structure 108, which is described in more detail below.

The one or more data structures 108 associate each decision tree with leaf invalidation pairs for factor-value pairs. A “leaf invalidation pair” as described herein corresponds to an index of a first leaf of a particular internal node (e.g., a branch node) of a decision tree that is invalidated when the internal node evaluates to a “FALSE” Boolean signal. An “invalidation” typically corresponds to a leaf node that is not traversed or used to obtain a score for scoring one or more search result candidates. The leaf invalidation pair also includes an index of the last leaf the internal node invalidates when it evaluates to FALSE. In particular embodiments, the leaf invalidation pair only includes these first and last leaves and no other leaves. In some embodiments, however, the leaf invalidation pair describes a range of leaves that are invalidated with the associated node evaluates to FALSE. For example, the first and last leaf described above may define a beginning and endpoint of a range of leaves that are invalidated. Alternatively or additionally, each value in the range of leaves may be identified other than just the beginning and end value. The one or more data structures 108 can utilize any number of leaves and uses a compact approach to store which decision tree leaves are invalidated, which reduces the size of the structure while improving memory access and CPU time. The one or more data structures 108 are described in more detail below.

The one or more decision trees 110 in various embodiments is a set of graphs that uses a branching method to illustrate every possible outcome of a decision. Decision trees can be linearized into decision rules, where the outcome is the contents of the leaf node, and the conditions along the path form a conjunction in an “if” clause, for example. In some embodiments, decision trees use learning or predictive modeling (e.g., data mining, machine learning, etc.) to go from observations about an item (e.g., represented in the branches) to conclusions (e.g., score relevance) about the item's target value or score represented in the leaves. As described herein, the one or more decision trees 110 is or includes one or more decision tree data structures that are utilized to score one or more features of a query. The one or more decision trees can be or include: boosted trees (e.g., GDBTs), classification trees, regression trees, bootstrap aggregated trees, rotation forest, and/or any suitable type of decision tree.

The one or more scoring modules 112 scores each search result candidate for the query/document input 102. A “search result candidate” includes one or more identifiers that are candidates for being provided as a query result set and that describes or is associated with one or more resources, such as products for sale, documents, web pages, links, etc. For example, a search result candidate can correspond to a product title of a product for sale (e.g., “$20-green toy car”), a document (e.g., a particular PDF document), a web page, a link (e.g., a URL link to one or more images), and/or any other identifier corresponding to content that can be returned in a result set of a query.

The one or more search result output modules 114 rank or sort search results based on the scoring performed by the one or more scoring modules 112. For example, in response to scoring one or more search result candidates, the search result output module(s) 114 may rank a data set based on the scoring and cause a user device to display search results based on the sorting or ranking, such as displaying a first document first on a top portion of a web page, which may be scored the highest.

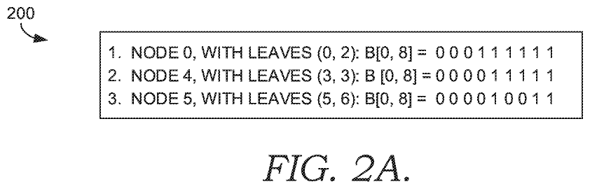

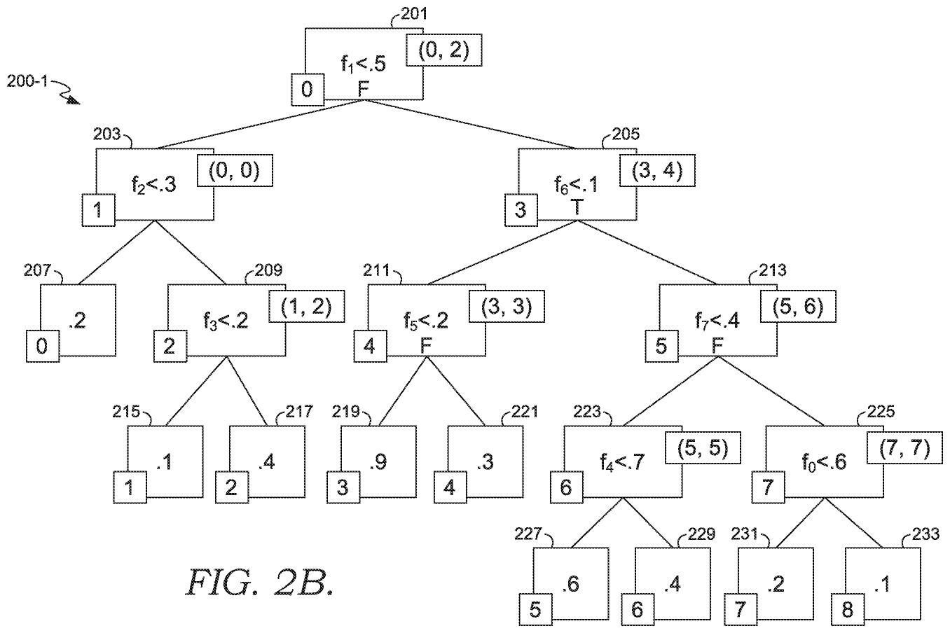

FIG. 2A is a schematic diagram of a bitmap 200 implemented by aspects of the present disclosure, according to some embodiments. Although the bitmap 200 is represented with particular values and records, it is understood that the bitmap 200 is representative only and that any particular suitable value may be illustrated with any quantity of records. FIG. 2A illustrates a running example in which node 0, 4, and 5 are evaluated to false and node 0 is evaluated, generating the bitmap associated with point 1. Subsequently when node 4 is evaluated, which will flip bits (3,3), resulting in the bitmap illustrated point 2 and continuing with point 3, etc. In various embodiments, for every tree evaluation in a decision tree forest, a bitmap is generated with all bits set to 1. Each bit in a record corresponds to a particular leaf node of a given decision tree indicating whether the particular leaf node is reachable for a given other node of a decision tree. In some embodiments, a bitmap is generated B[1, L], where 1 represents that all bits are set to 1 at a first time indicating that the corresponding leaves are reachable and where L is the quantity of leaves of a given decision tree. In some embodiments, as illustrated in FIG. 2A, a bitmap is generated B[0, L], where there are L+1 leaves. In the example of the bitmap 200, there are 9 leaf nodes represented (i.e., 9 bits) associated with a decision tree (e.g., the decision tree 200-1 of FIG. 2B). In an example illustration of the first time where each bit is set to 1, the first record (i.e., 1.), node 0 can have the following bit sequence: 111111111, indicating that each of the 9 leaf nodes are reachable for node 0. In some embodiments, the bitmap 200 is generated offline or outside of a user request.

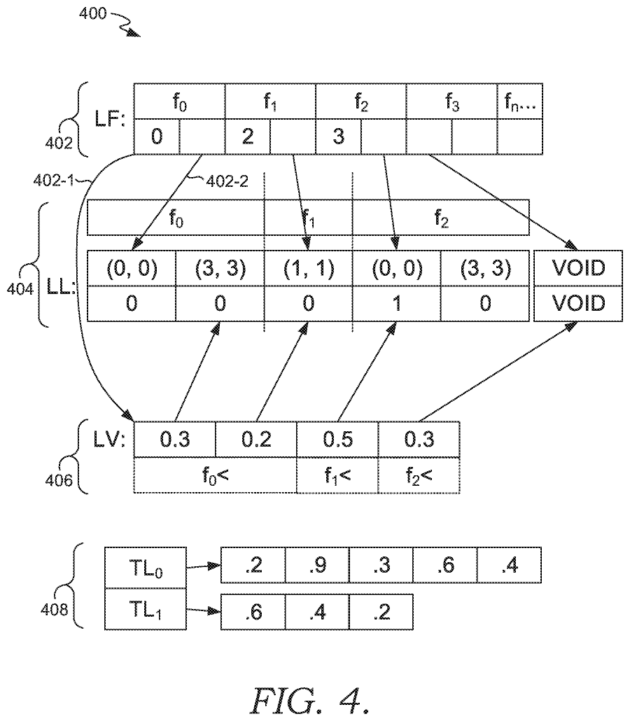

When a bit is flipped to 0, in some embodiments this indicates that a particular leaf is not reachable. For example, at a second subsequent time (as represented by the bitmap 200), the system (e.g., the bitmap module 106) identifies which leaves to invalidate or set to 0. In order to do this, all tree nodes are evaluated to determine whether the conditions associated with the factors/values are TRUE or FALSE, which is described in more detail in FIG. 2B below. The bitmap 200 indicates that nodes 0, 4, and 5 are all evaluated to be FALSE as indicated by the illustration of the three entries or records—1, 2, and 3—corresponding to nodes 0, 4, and 5. For the nodes that are evaluated to be FALSE, the leave's indices or leaf invalidation pairs are accessed, which are (0,2), (3,3), and (5,5) for nodes 0, 4, and 5 respectively. In some embodiments, in response to these indices or leaf invalidation pairs being identified, they are stored to a data structure (e.g., the data structure 400 of FIG. 4). These leaf indices for each node are “leaf invalidation pairs,” as described above, which indicate a range of leaves that are invalidated or need to be invalidated in response to a node evaluating to FALSE. For instance, as illustrated by record 1 of the bitmap 200, for node 0, the system flips the first 3 bits (i.e., leaves 0,2) to 0, indicating that each leaf 0, 1, 2 (i.e., the range of non-reachable leaves) is not reachable for node 0, resulting in the bit sequence 000111111. Likewise, for record 2 or node 4, bits from (3,3) are flipped (i.e., one bit in the fourth position from the left) indicating that the additional leaf 3 is not reachable for node 4, resulting in the bit sequence 000011111. Likewise, for record 3 or node 5, the fifth and sixth bits are flipped to 0 additionally indicating that leaves (5, 6) are not reachable, resulting in the bit sequence 000010011. The result of the bitmap 200 analysis is that the first reachable leaf of the decision tree is leaf 4 (the first position K of the bitmap that indicates that a particular leaf is reachable), which is the fifth bit or position from the left indicated by the 1 value. The result of the bitmap 200 is described in more detail below.

FIG. 2B is a schematic diagram of a decision tree 200-1 (e.g., a modified version of a GDBT) in which aspects of the present disclosure can be implemented, according to embodiments. It is understood that although the decision tree 200-1 illustrates a specific quantity of nodes with particular values, the decision tree 200-1 is representative only. Accordingly, more or fewer nodes may exist along with different value. The decision tree 200-1 includes the root node 201, branch nodes 203, 205, 209, 211, 213, 223, and 225, and the leaf nodes 207, 215, 217, 219, 221, 227, 229, 231, and 233. The decision tree 200-1 indicates node identifiers, whether a factor value of a query/search result candidate meets a conditional test or constant, and the corresponding node's leaf invalidation pair. For example, within the root node 201, the node identifier is indicated by the “0” value on the bottom left hand corner of the root node 201 indicating that this is root node 0. Further, root node 201 illustrates the conditional test to determine whether the corresponding factor value passes the test. For example, the conditional test is “f₁<0.5” corresponding whether a first factor value (f₁) is less than the value 0.5. The Boolean value “F” or FALSE is also illustrated within the node 201, which indicates that a current query/search result candidate factor value (e.g., price) is not less than 0.5. For example, a value 1.2 may be extracted from a query/document and compared to the conditional test F<0.5. Because 1.2 is greater than 0.5, the node 201 is evaluated to be FALSE. In some embodiments, FIG. 2B is processed offline outside of a query request.

A ranking model, which may include a decision tree, is typically defined as a function that maps a pair (e.g., document, query) to a floating-point value (e.g., the 0.3 score within the node 221). Each of the leaf nodes 215, 217, 219, 221, 227, 229, 231, and 233 hold a floating point value, which means that each of these nodes are candidates for passing the value for scoring a search result candidate. In various embodiments, only one of the floating point values corresponding to one leaf node is used as a score to score search result candidates. This single score is then added to the total document/search result candidate score. Each individual decision tree score may then be added or integrated with all of the other decision tree scores to come up with a final search result candidate score.

Embodiments of the present disclosure utilize the leaf invalidation pairs, one or more bitmaps, and one or more novel data structures to score search result candidates, as opposed to starting from the root node 201 and traversing through each of the branches (e.g., start going left to node 203, or right to 205) based on whether the conditional test is passed or failed as identified by the Boolean value (TRUE or FALSE). The order in which internal decision tree nodes are evaluated is typically not important because scoring is based on whether leaves are reachable and not reachable as opposed to knowing which branch nodes are affected for the invalidation process. Accordingly, a top-down traversal of the decision tree 200-1 is not necessary. Therefore, an implementer may decide which order is best. This has an immediate benefit of avoiding branch mispredictions as described above.

When a root or branch node becomes FALSE or the conditional test is not met as indicated by the associated Boolean value, the left subtree or left child nodes automatically become unreachable, including all branch nodes and corresponding leaf nodes. The reverse occurs when a node becomes true (i.e., the right sub-trees are invalidated). This means that all leaf nodes descending from the particular FALSE nodes will not be used as the final leaf node for scoring. For example, because the conditional test of node 201 is evaluated to be FALSE (“F”), every descendant node of node 201 is unreachable (nodes 203 and 209) and the associated leaf nodes-207, 215, and 217—are invalidated or not used to score search result candidates, which is reflected in the leaf invalidation pairs for node 0—(0, 2)—which indicates that each of the leaf nodes 0, 1, 2 (i.e., leaf nodes 207, 215, and 217) are invalidated. Accordingly, in some embodiments the system (e.g., the search engine system 100 of FIG. 1) first determines which nodes hold FALSE Boolean values based on whether a conditional test is met. Then the system accesses or generates the FALSE nodes' leaf indices or leaf invalidation pairs (e.g., the first and last leaf node invalidated in an ordered range of leaf nodes). For example, the decision tree 200-1 indicates that nodes 201, 211, and 213 were all evaluated to be FALSE. Each of these nodes are then entered as entries or records within the bitmap 200 of FIG. 2A, along with the nodes' corresponding leaf invalidation pairs. The bitmap 200 is then generated as described with reference to FIG. 2A. Both the decision tree 200-1 and the bitmap 200 indicate that the only reachable leaf node is node 3 (i.e., leaf node 221). The bitmap 200′s first K reachable leaf or leftmost 1 bit value is in position 4, leaf node 3 (i.e., node 221). Accordingly, leaf node 221's floating point value 0.3 is then used for scoring search result candidates. This is more computationally efficient (e.g., in terms of CPU) compared to existing technologies that first traverse the root node 201, and based on the FALSE Boolean value, traverse node 205 and based on the TRUE Boolean value of node 205, traverse to the left to node 211, and based on node 211's FALSE Boolean value, arriving at the leaf node 221 (i.e., node 3) to finally arrive at a score.

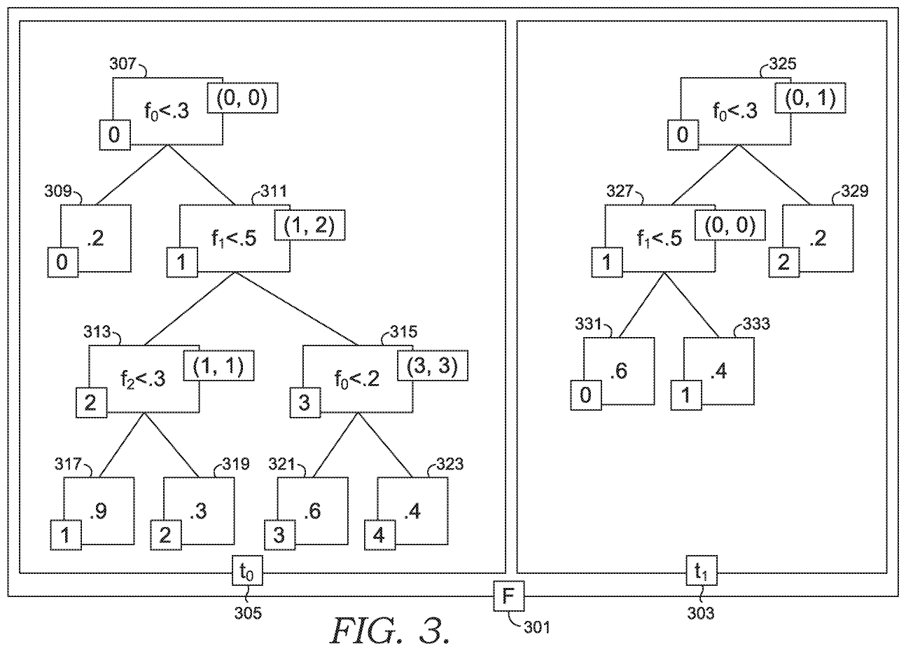

FIG. 3 is a schematic diagram of a forest 301 of decision trees in which aspects of the present disclosure may be implemented, according to some embodiments. There are two decision trees 305 (t₀) and 303 (t₁) in the forest 301 (“f”). Decision tree 301 includes the root node 307, branch nodes 311, 313, and 315, each of which include leaf invalidation pairs (e.g., (0,0), node identifiers, and conditional tests. The decision tree 301 further includes leaf nodes 309, 317, 319, 321, and 323. The decision tree 303 includes the root node 325, branch node 327, and leaf nodes 329, 331, and 333. In some embodiments, a data structure is generated based on the results of analyzing the forest 301, which is described in more detail below with respect to FIG. 4.

FIG. 4 is a block diagram of a data structure 400 in which aspects of the present disclosure are implemented, according to some embodiments. Although FIG. 4 illustrates particular values associated with a particular quantity of factors, it is understood that the particular values and factors are representative only and that any particular value and quantity of factors may exist. FIG. 4 describes an inverted index where terms or entries are pairs of factors and values (Fᵢ, Vᵢ), as the quantity of different values a factor may have in an entire forest of decision trees is limited. “Factor-value pairs” as described herein corresponds to factors and values that appear in non-leaf nodes (i.e., branch and root nodes). In some embodiments, these factor-value pairs are generated offline outside of a query request. These factor-value pairs are different from some existing search engine technologies that traverse portions of all decision trees or data structures factor by factor or feature by feature without indexing based on values of the factors, which increases the size of data structures thereby decreasing storage capacity as well as reduce CPU access time as described above. For each pair (F₁, Vᵢ), there can be a list that, for each position, includes a leaf invalidation pair associated to factor Fᵢ and value Vᵢ in the decision tree identified by X, which is the ID of the decision tree that the pair (Fᵢ, Vᵢ) belongs to. This list illustrated by the LL list 402. The LL list 402 is a single list that includes the leaf invalidation pairs (e.g., (0,0), (3,3)) to all trees in a forest, which is first sorted by factor id (factor sub-index) (e.g., f) and then by the factor's value. The list LL list 402 also includes the tree ID the factor-value pair (Fᵢ, Vᵢ) belongs to (e.g., 0).

The List of Values (LV) 406 includes all values (e.g., 0.3) associated to all factors (e.g., f₁<) of all decision trees in a forest. In particular embodiments, these factors are sorted first by factor and then sorted by the corresponding value in descending order. The LV list 406 also includes pointers to the LL list 402 pointing to the same factor and value within the LL list 402, plus a value of 1. These pointers also point to a “VOID” cell when the smallest value of the last factor is reached (e.g., 0.3 of f₂ points to the “VOID” box). The “VOID” cell is a signal indicating that all factors for a given query/document has been associated and any other factors/values are not associated with the query/document.

The List of Factors (LF) 402 includes each factor of a decision tree forest, which is sorted by factor. These factors include 2 pointers. The first pointer 402-1 points to the largest value of factor F₁ in the LV list 406, which is shown by the “0” value in the LF list 402 pointing to the “0.3” value in the LV list 406. The second pointer 402-2 points to the first cell associated with factor Fo in the LL list 404, which corresponds to leaf invalidation pair (0,0) and tree ID 0.

The Tree Leaves (TL) list 408 includes a pointer that maps particular decision trees (TL₀and TL₁) to individual tree leaves (e.g., 0.2) to point to a list indexed by leaf index, and at each position j, a decimal value is associated to the j^{th} leaf of the I^{th} Tree. The decimal values (e.g., 0.2, 0.9, 0.3, 0.6, and 0.4) each represent corresponding leaf values for a given decision tree, which are each candidate leaves for scoring. When one of the values is selected for scoring search results, the decision tree identifier (e.g., TL₀) points to the value of the last reachable leaf.

In some embodiments, the data structure 400 includes values based on the decision tree forest 301 of FIG. 3. For example, a user may issue a query and the system identifies each of the factors (fₒ, fᵢ, and f₂) associated with the query and search result candidate and each of its corresponding values (vₒ, vᵢ, and v₂). In some embodiments, in response to the values being obtained, two bitmaps, having been previously generated offline, are looked up. The two bitmaps Bₒ[0, 5] and B₁[0, 3] are located because there are 2 decision trees in the forest 301, where 5 and 3 are the quantity of leaves of t₀ (i.e., tree 305) and t₁ (tree 303) respectively. Accordingly, referring back to FIG. 3, tree 305 includes the five leaves—309, 317, 319, 321, and 323. Tree 303 includes 3 leaves—329, 331, and 333. In particular embodiments, each bit is set to 1 in both bitmaps.

For each factor (fₒ, fᵢ, and f₂) illustrated in FIG. 3, the LF list 402 is accessed to identify and match the corresponding factors in the data structure. For example, the factor fₒ is identified in the LF list 402. The factor fₒ in the LF list 402 points to the first cell or node in in the LL list 402 via the pointer 402-2, which corresponds to the smallest value 0.2 for factor fₒ. The factor fₒ in the LF list 402 also points to the largest value in the LV list 406 for factor fₒ via the pointer 402-1, which is 0.3. In some embodiments, the system (e.g., the scoring module 112 of FIG. 1) iterates forward in the LV list 406, starting with the smallest value (0.2), until all the values for factor fₒ have been identified and the largest value (i.e., 0.3) for factor fₒ has been reached. In this way, each factor and each value of each factor can be identified for the decision trees.

In some embodiments, in response to associating each factor with a set of values, every element in the LL list 404 is processed. Accordingly, for every factor-value pair, the system can associate these pairs with tree ID, which is illustrated as being either 0 (i.e., tₒ) or 1 (i.e., tᵢ) within the LL list 404. The TL list 408 is accessed to set/flip bits in a bitmap by mapping (e.g., via a pointer) each decision tree identified in the LL list 404 to a corresponding tree ID in the TL list. The decimal values (e.g., 0.2, 0.9, 0.3, 0.6, and 0.4) each represent corresponding leaf values for a given decision tree, which are each candidate leaves for scoring. These values are reflected in FIG. 3 in the leaves. Accordingly, each bit is set to 0 in the range specified by the leaf invalidation pairs indicated in the LL list 404. After the bits are flipped to zero, for each bitmap, the first k position in a bitmap set to 1 is located, as described in FIG. 2A above.

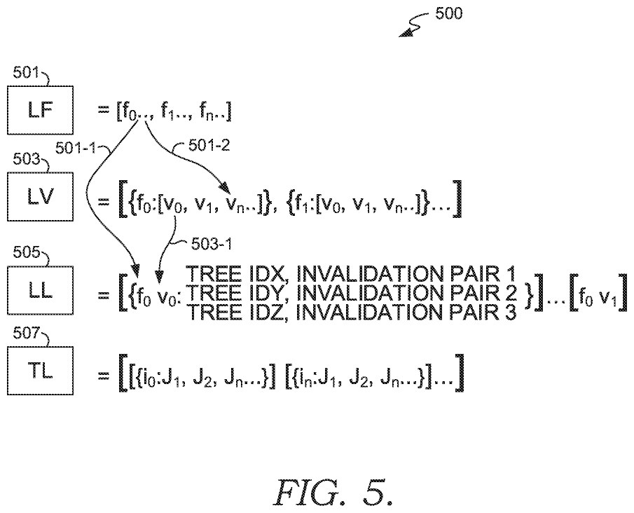

FIG. 5 is a schematic diagram of one or more data structures 500 in which aspects of the present disclosure may be implemented, according to particular embodiments. In some embodiments, the data structure 500 is similar to or analogous to the data structure 400 of FIG. 4 and performs the same or analogous functions. The LF list 501 includes an ordered list data structure of factors and/or values fₒ, fᵢ, and fₙ, which represent every or some specific factors of a query, result set, and/or decision tree. Each factor holds two pointer values. For example, FIG. 5 illustrates the factor fₒ, within the LF list 501 maps to the same factor, starting with the first cell within the LL list 505 according to the pointer 501-1. Further, factor fₒ, within the LF list 501 additionally maps to the largest value Vₙof the LV list 503, as illustrated by the pointer 501-2. In some embodiments, the LV list 503 is a list of dictionary or hash map key-value pairs. Accordingly, in some embodiments, the LV list 503 is a list that includes various embedded hash maps. For example, within the LV list 503, the factor fₒ, may be the “key.” The “value” portion may be a list of values—V₀, V₁, and Vₙ—that each share the same factor fₒ, As illustrated in the LV list 503, each factor is associated with its own particular values. For example, V₀, V₁, and Vₙ may each be different prices for a price factor.

Each value for a particular factor is also mapped or associated with a factor-value pair within another embedded list in some embodiments. For example, the pointer 503-1 maps the value Vₒ of factor fₒ, to a matched value and factor within the LL list 505. As illustrated in the LL list 505, each factor-value pair corresponds to a Key (e.g., fₒ,Vₒ) within the LL list 505 and is associated with the values, which include the tree ID where the particular factors are located and each leaf invalidation pair of those factors. For instance, the LL list 505 illustrates that factor fₒ associated with vₒ is located in Tree ID X, ID y, and ID Z, each of which respectively include leaf invalidation pairs 1, 2, and 3. In this way, each value of each factor is associated with the various decision trees that include such factors and conditional tests and the associated leaf invalidation pairs for the value. For instance, referring back to FIG. 2B, there is only one type of factor f₁ within the decision tree 200-1. Accordingly, a value extracted from a query/result set may be associated with the factor f₁ and be implemented as a factor-value pair key within the LL list 505 and associated with the hash map value tree ID and leaf invalidation pairs to determine or associate the particular values and/or factors of the query/result set with each decision tree that analyzes the factors in the query/search result candidates. For example, the LL list 505 may include values that give the ID of decision tree 200-1 and only the leaf invalidation pair (0, 2) since this decision tree 200-1 only included the factor fi a single time at the root node 201, which means that only the invalidate pair (0,2) is listed and not the other leaf invalidation pairs within the decision tree 200-1. Per the TL list 507, each tree i is listed and mapped to its corresponding leaves J.

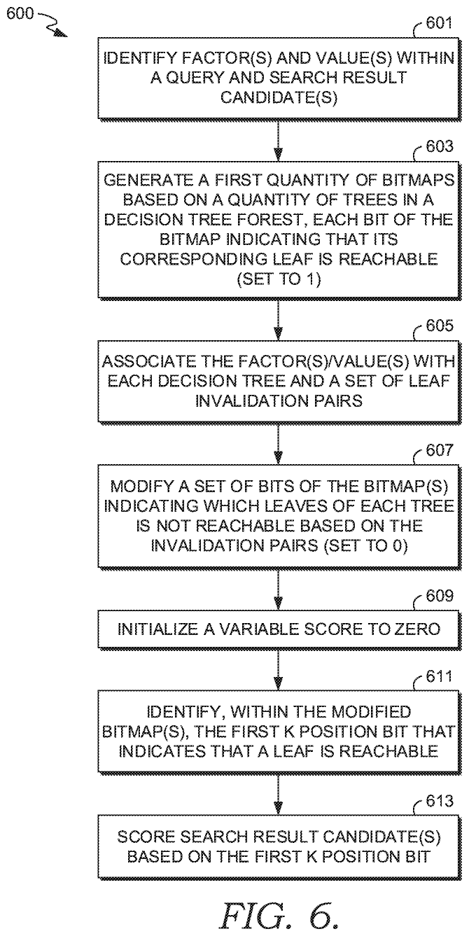

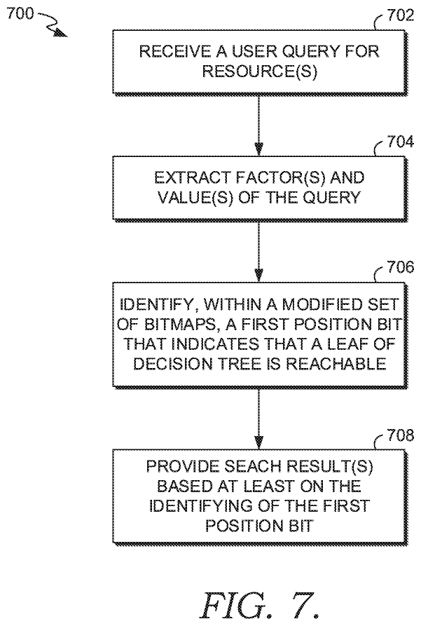

FIG. 6 is a flow diagram of an example process 600 for scoring one or more search result candidates based on a first k position bit in a bitmap, according to embodiments. The process 600 (and/or processes 700) may be performed by processing logic that comprises hardware (e.g., circuitry, dedicated logic, programmable logic, microcode, etc.), software (e.g., instructions run on a processor to perform hardware simulation), firmware, or a combination thereof. Per block 601, one or more factors and values within a query and one or more search result candidates are identified (e.g., by the factor extraction module(s) 104 of FIG. 1). For example, various attributes and values can be extracted from queries/documents, such as price specifications (e.g., from a document labeled “sunglasses $25”), time values, etc. In some embodiments, some or each of the blocks in FIG. 6 are performed “offline” or separate from executing a query or “runtime.” For example, in some embodiments, these blocks occur before the process 700 of FIG. 7

Per block 603, a first quantity of bitmaps are generated (e.g., by the bit map module(s) 106 of FIG. 1) based on a quantity of trees in a decision tree forest that hold the corresponding factor values. Each bit of a bitmap indicates that its corresponding leaf is reachable. For example, referring back to FIG. 2A, at a first time, each of the bits in the bit array for nodes 0, 4, and 5, are set to 1 indicating that each leaf is reachable. For every tree that holds the factors and values of a query/search result candidate, bitmaps are generated, which may be offline as described above. As FIG. 2A illustrates, each bitmap includes a particular quantity of records based on a quantity of nodes that are evaluated to be FALSE and the quantity of bits in the array depends on the quantity of leaves the corresponding decision tree includes.

Per block 605, each of the identified/extracted factor(s) and value(s) are associated (e.g., by the bit map module(s) 106) with each decision tree in a forest that holds those factor/value(s) and a set of leaf invalidation pairs. In some embodiments, data structures, such illustrated in FIG. 4 and/or FIG. 5 are utilized for the association in block 605. For example, referring back to FIG. 5, within the LL list 505, each factor-value pair (e.g., F0 V0) is a key that includes tree ID values and the leaf invalidation pairs of the particular tree ID. In another example, referring back to FIG. 4, the LL list 404 includes the factor and value (e.g., F0), the leaf invalidation pairs (e.g., (0,0)), and the tree ID associate with factor-value pairs and leaf invalidation pairs (e.g., “0”) .

Per block 607, a set of bits of the one or more bitmaps are modified to indicate which leaves of each tree is not reachable based on the leaf invalidation pairs. For example, referring back to FIG. 2A, offline or during non-runtime situations, the system (e.g., the bitmap module(s) 106) may first identify which nodes are evaluated to be FALSE in the decision tree(s) that have values that hold the extracted/identified factor/value(s). Then, each of the leaves that are invalid or non-reachable can be identified. Responsively, each leaf invalidation pair can be generated and implemented within the data structure of FIG. 4 and/or FIG. 5. In some embodiments, the system then responsively modifies the set of bits of the one or more bitmaps indicating which leaves of the decision trees are not reachable based on what the leaf invalidation pairs are in the data structure.

Per block 609, a score for a document/query is initialized to zero to begin the scoring process where the score increases based on the first K position. Per block 611, the first K position bit is identified (e.g., by the scoring module(s) 112) within the modified bitmap(s). The first K position bit indicates that a leaf is reachable (e.g., the bit is set to 1). For example, referring back to FIG. 2A, going from a left to right reading, the first bit that is a 1 (reachable) is the third bit corresponding to leaf node 4 (i.e., node 221).

Per block 613, one or more search result candidates are scored based at least in part on the first K position bit. For example, referring back to FIG. 2A and 2B, leaf node 221 holds the floating point value of 0.3. Accordingly, this value for this attribute/factor is added to the final score in preparation to execute a query against a set of results. In various embodiments, block 613 is used for run-time situations in which a user issues a query. Accordingly, in response to a user issuing a query, one or more factors and/or values of the query may be extracted or identified. These factors and/or values may then be matched against a set of identical factors and/or values that have been processed offline. Responsively, the search engine system may look for the first bit flipped indicating reachability for each relevant tree (e.g., as described in FIG. 2A), as opposed to traversing each tree at run-time, which is costly for the reasons described above. In some embodiments, the scoring of the one or more search result candidates is alternatively or additionally based on other factors, such as associating a plurality of decision trees with one or more leaf invalidation pairs for at least the first value of the one or more factors within the data structure, as described in block 605.

In various embodiments, the process 600 is associated with a ranker function that maps each (document, query) pair with a score. Accordingly, each document can be evaluated separately. Therefore, for each (document, query) pair, the bitmaps as described above are created (e.g., block 603) in particular embodiments, as one document at a time is evaluated. Once the score for all documents in a data set are calculated, then the documents can be ranked or sorted. For example, if there is a database of documents D=[d₀, d₁, d₂, d₃, and d₄], when the system receives the query Q (e.g., a runtime user request), in order to sort all the documents in D according to the query Q, the following algorithm according to the process 600 is as follows in certain embodiments: for each document d in D: BEGIN OF FOR LOOP of blocks 601, 603, 605, 607, 609, and 611. After block 611, add all the scores associated with the leaves detected in block 611 to the variable initialized in block 609. This will be the score for document d in D. END OF FOR LOOP. Once the scores for each of the documents d are obtained, they are then sorted and returned to the user.

FIG. 7 is a flow diagram of an example process 700 for providing search results for a user request, according to some embodiments. In some embodiments, FIG. 7 represents a run-time query execution process where a user starts a session to request resources, which occurs after some or each of the process 600 blocks of FIG. 6. Per block 702, a query is received (e.g., by the factor extraction module(s) 104 of FIG. 1) for one or more resources (e.g., products, documents, links, websites, etc.). For example, a user may open a portal and input a query string within a search engine field. In some embodiments a portal is not necessary to receive the query, but rather a query can be received via a public search engine or website such that no login is required (e.g., authentication and/or authorization information) and anyone can view the information. In response to a user inputting a query, such as a string of characters (e.g., “cheap jewelry”), the query is transmitted to the system.

Per block 704, one or more factors and/or values of the query and/or search results candidate are identified extracted (e.g., by the factor extraction module 104). For example, a user may issue the query “cheap toy cars.” Accordingly, factors and/or values of price and toy cars are identified. Per block 706, a first position bit, within a modified set of bitmaps, are identified, which indicates that a particular leaf of one or more decision trees are reachable. Referring to the example above, the factors and/or values associated with price and toy cars may be matched against decision trees and/or bitmaps that include the same factors and/or values. Referring back to 2A, the first position bit indicating that a leaf for a tree is identified, which is 3^{rd} leave, with a floating point value of 0.3 In some embodiments, one or more data structures are analyzed (e.g., via the bit map module(s) 106), which associate one or more decision trees with one or more leaf invalidation pairs for one or more factor-value pairs. For example, after one or more factors are extracted (e.g., via the factor extraction module(s) 104), those factors are located in a data structure and are mapped to each decision tree ID that the factors belong to and mapped to leaf invalidation pairs for those factors, as illustrated in FIG. 4 and/or FIG. 5 above.

Per block 708, one or more search results are provided based at least on the identifying of the first position bit (and/or any of the steps indicated in the process 600). In these embodiments, an output is provided (e.g. via the search result output module(s) 114) that causes search results to be sorted on a user device. For example, the search engine system 100 can transmit sorted results to a user device, which causes the user device to display ranked results corresponding to the score. In one example, the results are ranked by relevancy from a top-down approach, where a first search result at the very top of a page is the highest scoring candidate and the second search result on the last page is the lowest scoring candidate. Accordingly, the first search result is more relevant than the second search result. In some embodiments, search result candidates are scored immediately before the providing at block 708 (e.g., as opposed to scoring at block 613 of FIG. 6). For example, in response to locating each of the tree IDs and leaf invalidation pairs associated with the factors of the query/search result candidate set, the system can identify the first K position leaf that is reachable (set to 1), is mapped to its associated floating point value, as illustrated in FIG. 2A. In some embodiments, the providing of the search results is alternatively or additionally based on other factors, such as data structure values (e.g., the data structures of FIG. 4 and/or 5), or other modeling predictions (e.g., random forests), word embedding vector models (e.g., WORD2VEC), TF-IDF, etc. In some embodiments, the scoring or the providing of the search results are based on some or each of the blocks in the processes 600 and/or 700 of FIGS. 6 and/or 7 respectively.

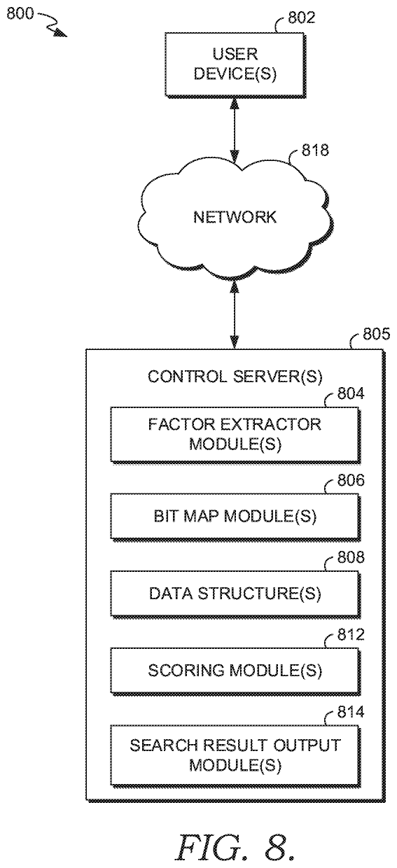

FIG. 8 is a block diagram of a computing environment 800 in which aspects of the present disclosure can be implemented within, according to particular embodiments. The computing environment 1000 includes one or more user devices 802 and one or more control servers, each of which are communicatively coupled via one or more networks 818. In some embodiments, the computing environment 800 may be implemented within a cloud computing environment, or use one or more cloud computing services. Consistent with various embodiments, a cloud computing environment includes a network-based, distributed/data processing system that provides one or more cloud computing services. Further, a cloud computing environment can include many computers, hundreds or thousands of them or more, disposed within one or more data centers and configured to share resources over the network 818. For example, the one or more control servers 805 may include several computers that are each associated with a single component within the search engine system 100 of FIG. 1 and/or the modules within the control server(s) 805. For example, a first computer may host the factor extraction module(s) 804 and a second computer may host the bit map module(s) 806, etc.

These components can communicate with each other via the network(s) 816, which can be or include any suitable network such as a Personal Area Network (PAN) (e.g., a Bluetooth® (by BLUETOOTH SIG) network), a local area network (LAN), a general wide area network (WAN), and/or a public network (e.g., the internet).

In some computing environments, more or fewer components may be present than illustrated in FIG. 8. In various embodiments, some or each of the components represent separate computing devices. In some embodiments, some or each of the components represent particular compute instances of a single computing device (e.g., program modules, computing components within a chassis, a blade server within a blade enclosure, an I/O drawer, a processor chip, etc.)

In some embodiments, the computing environment 800 is the environment in which the processes 600, 700, and/or any other action described herein can be implemented within. The user device(s) 802 include any device associated with a user, such as a mobile phone, desktop computer, sensor devices, etc. In some instances, these devices include a user interface and/or query interface. Users can also transmit requests from the one or more user devices 802, such as the query input 102 of FIG. 1.

The one or more control servers 805 in embodiments represent the system that acts as an intermediary or coordinator for executing the one or more queries from the one or more user devices 802. For example, in some embodiments the one or more control servers 805 includes some or each of the components as described in FIG. 1. The one or more control servers include the factor extraction module(s) 804, the bit map module(s) 806, data structure(s), the scoring module(s) 812, and the search result output module(s) 814, each of which may be similar or identical to the corresponding modules within the system 100.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

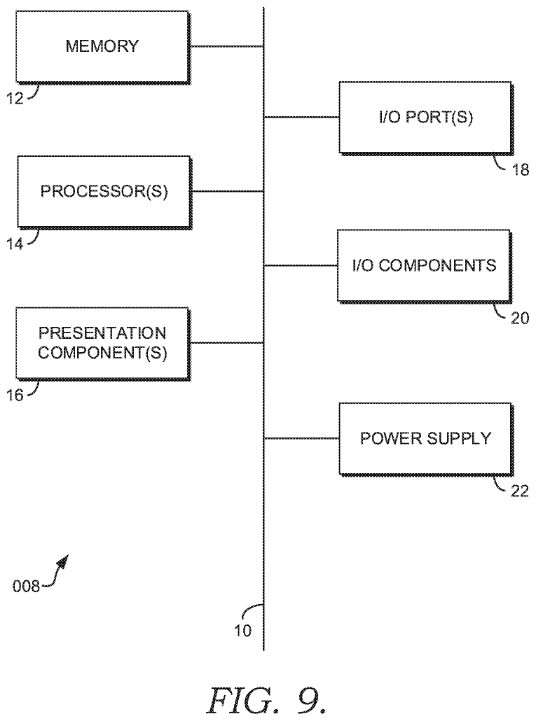

With reference to FIG. 9, computing device 008 includes bus 10 that directly or indirectly couples the following devices: memory 12, one or more processors 14, one or more presentation components 16, input/output (1/O) ports 18, input/output components 20, and illustrative power supply 22. Bus 10 represents what may be one or more busses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that this diagram is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 9 and reference to “computing device.”

In some embodiments, the computing device 008 represents the physical embodiments of one or more systems and/or components described above. For example, the computing device 008 can be the one or more user devices 802 and/or control server(s) 805 of FIG. 8. The computing device 008 can also perform some or each of the blocks in the processes 600 and/or 700. It is understood that the computing device 008 is not to be construed necessarily as a generic computer that performs generic functions. Rather, the computing device 008 in some embodiments is a particular machine or special-purpose computer. For example, in some embodiments, the computing device 008 is or includes: a multi-user mainframe computer system, a single-user system, or a server computer or similar device that has little or no direct user interface, but receives requests from other computer systems (clients), a desktop computer, portable computer, laptop or notebook computer, tablet computer, pocket computer, telephone, smart phone, smart watch, or any other suitable type of electronic device.

Computing device 008 typically includes a variety of computer-readable media. Computer-readable media can be any available media that can be accessed by computing device 008 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 008. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 12 includes computer storage media in the form of volatile and/or nonvolatile memory. The memory may be removable, non-removable, or a combination thereof. Exemplary hardware devices include solid-state memory, hard drives, optical-disc drives, etc. Computing device 008 includes one or more processors 14 that read data from various entities such as memory 12 or components 20. Presentation component(s) 16 present data indications to a user or other device. Exemplary presentation components include a display device, speaker, printing component, vibrating component, etc.

I/O ports 18 allow computing device 008 to be logically coupled to other devices including I/O components 20, some of which may be built in. Illustrative components include a microphone, joystick, game pad, satellite dish, scanner, printer, wireless device, etc. The I/O components 20 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 008. The computing device 008 may be equipped with depth cameras, such as, stereoscopic camera systems, infrared camera systems, RGB camera systems, and combinations of these for gesture detection and recognition. Additionally, the computing device 008 may be equipped with accelerometers or gyroscopes that enable detection of motion.

As described above, implementations of the present disclosure relate to automatically generating a user interface or rendering one or more applications based on contextual data received about a particular user. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

Embodiments of the present disclosure generally include a computer-implemented method, a non-transitory computer storage medium, and a system. In one aspect, the computer-implemented method can include the following operations. One or more factors of a query and one or more search result candidates are identified. A data structure associates a plurality of decision trees with one or more leaf invalidation pairs for at least a first value of the one or more factors. The one or more search result candidates are scored based at least in part on the associating of the plurality of decision trees with one or more leaf invalidation pairs for at least the first value of the one or more factors within the data structure.

In another aspect, the non-transitory computer storage medium can store computer-useable instructions that, when used by one or more computing devices, cause the one or more computing devices to perform the following operations. A query request is received for one or more resources. One or more factors of the query are identified. Within a modified set of bitmaps, a first position bit that indicates that one or more leaves are reachable of one or more decision trees are identified. The modified set of bitmaps are generated based at least on a data structure that associates one or more values within one or more decision trees with a set of leaf invalidation pairs. One or more search results are provided based at least on the identifying of the first position bit.

In yet another aspect, the system can include at least one computing device having at least one processor. The system can further include at least one computer readable storage medium having program instructions embodied therewith. The program instructions can be readable/executable by the at least one processor to cause the system to perform the following operations. One or more factors of one or more search result candidates are identified. A data structure is generated that associates a plurality of decision trees with a range of leaves that have been invalidated for one or more nodes of the plurality of decision trees for at least a first value of the one or more factors. One or more search result candidates are scored based at least in part on analyzing the data structure.

### DEFINITIONS

“And/or” is the inclusive disjunction, also known as the logical disjunction and commonly known as the “inclusive or.” For example, the phrase “A, B, and/or C,” means that at least one of A or B or C is true; and “A, B, and/or C” is only false if each of A and B and C is false.

A “set of” items means there exists one or more items; there must exist at least one item, but there can also be two, three, or more items. A “subset of” items means there exists one or more items within a grouping of items that contain a common characteristic.

A “plurality of” items means there exists more than one item; there must exist at least two items, but there can also be three, four, or more items.

“Includes” and any variants (e.g., including, include, etc.) means, unless explicitly noted otherwise, “includes, but is not necessarily limited to.”

A “user” or a “subscriber” includes, but is not necessarily limited to: (i) a single individual human; (ii) an artificial intelligence entity with sufficient intelligence to act in the place of a single individual human or more than one human; (iii) a business entity for which actions are being taken by a single individual human or more than one human; and/or (iv) a combination of any one or more related “users” or “subscribers” acting as a single “user” or “subscriber.”

The terms “receive,” “provide,” “send,” “input,” “output,” and “report” should not be taken to indicate or imply, unless otherwise explicitly specified: (i) any particular degree of directness with respect to the relationship between an object and a subject; and/or (ii) a presence or absence of a set of intermediate components, intermediate actions, and/or things interposed between an object and a subject.

A “data store” as described herein is any type of repository for storing and/or managing data, whether the data is structured, unstructured, or semi-structured. For example, a data store can be or include one or more: databases, files (e.g., of unstructured data), corpuses, digital documents, etc.

A “module” is any set of hardware, firmware, and/or software that operatively works to do a function, without regard to whether the module is: (i) in a single local proximity; (ii) distributed over a wide area; (iii) in a single proximity within a larger piece of software code; (iv) located within a single piece of software code; (v) located in a single storage device, memory, or medium; (vi) mechanically connected; (vii) electrically connected; and/or (viii) connected in data communication. A “sub-module” is a “module” within a “module.”

The terms first (e.g., first cache), second (e.g., second cache), etc. are not to be construed as denoting or implying order or time sequences unless expressly indicated otherwise. Rather, they are to be construed as distinguishing two or more elements. In some embodiments, the two or more elements, although distinguishable, have the same makeup. For example, a first memory and a second memory may indeed be two separate memories but they both may be RAM devices that have the same storage capacity (e.g., 4 GB).

The term “causing” or “cause” means that one or more systems (e.g., computing devices) and/or components (e.g., processors) may in in isolation or in combination with other systems and/or components bring about or help bring about a particular result or effect. For example, a server computing device may “cause” a message to be displayed to a user device (e.g., via transmitting a message to the user device) and/or the same user device may “cause” the same message to be displayed (e.g., via a processor that executes instructions and data in a display memory of the user device). Accordingly, one or both systems may in isolation or together “cause” the effect of displaying a message.

What is claimed is:

1. A computer-implemented method comprising:
identifying one or more factors of a query and one or more search result candidates;
associating, via a data structure, a plurality of decision trees with one or more leaf invalidation pairs for at least a first value of the one or more factors; and
scoring the one or more search result candidates based at least in part on the associating of the plurality of decision trees with one or more leaf invalidation pairs for at least the first value of the one or more factors within the data structure.

2. The method of claim 1, further comprising generating a first quantity of bitmaps based on a quantity of trees in a decision tree forest, the decision tree forest including the plurality of decision trees, each bit of the bitmap indicates that a corresponding leaf is reachable.

3. The method of claim 2, further comprising modifying a set of bits of the bitmaps indicating which leaves of each tree of the plurality of trees is not reachable based on the one or more leaf invalidation pairs.

4. The method of claim 1, further comprising analyzing a first structure that lists each factor of a decision tree forest, the structure including a first pointer that maps a first factor of the one or more factors to a largest value in a range of values associated with the first factor, the first structure includes a second pointer that maps the first factor to a portion of the data structure that corresponds with the associating the plurality of decision trees with one or more leaf invalidation pairs.

5. The method of claim 1, further comprising analyzing a first structure that lists a plurality of factors and each value associated with the plurality of factors, wherein the first structure includes a pointer that maps a first value of a first factor of the one or more factors to a portion of the data structure that corresponds with the associating the plurality of decision trees with one or more leaf invalidation pairs.

6. The method of claim 1, further comprising identifying, within a modified set of bitmaps, a first K position bit that indicates that a leaf is reachable, wherein the scoring of the one or more search result candidates is further based on the identifying of the first K position.

7. The method of claim 1, further comprising analyzing an index within the data structure that identifies a range of non-reachable leaves for each node of the plurality of decision trees evaluated to be false based on a Boolean signal, wherein the scoring of the one or more search result candidates is based further on analyzing the index.

8. A non-transitory computer storage medium storing computer-useable instructions that, when used by one or more computing devices, cause the one or more computing devices to perform operations comprising:
receiving a query request for one or more resources;
identifying one or more factors of the query;
identifying, within a modified set of bitmaps, a first position bit that indicates that one or more leaves are reachable of one or more decision trees, the modified set of bitmaps being generated based at least on a data structure that associates one or more values within one or more decision trees with a set of leaf invalidation pairs; and
provide one or more search results based at least on the identifying of the first position bit.

9. The computer storage medium of claim 8, wherein the one or more computing device perform further operations comprising setting, at a first time prior to the identifying, each bit of the modified set of bitmaps to a first value to indicate that all corresponding leaves are reachable for all trees.

10. The computer storage medium of claim 9, wherein the one or more computing device perform further operations comprising setting, at a second time prior to the first time, a set of bits of the modified set of bitmaps to a second value to indicate that a set of leaf nodes are not reachable based at least on the leaf invalidation pairs.

11. The computer storage medium of claim 8, wherein the one or more decision trees are Gradient Descent Boost Trees (GDBT), and wherein the one or more leaves are not reachable in response to identifying which nodes of the GDBT decision trees are associated with a false Boolean value.

12. The computer storage medium of claim 8, wherein the data structure that associates the one or more values within one or more decision trees includes a list data structure that includes an embedded hash map, wherein the embedded has map includes factor-value pairs that are associated with a tree ID and a particular leaf invalidation pair.

13. The computer storage medium of claim 12, wherein the data structure lists a plurality of factors and each value associated with the plurality of factors, and wherein the data structure includes a pointer that maps a first value of a first factor of the one or more factors to a portion of the data structure that corresponds with the associating the plurality of decision trees with one or more leaf invalidation pairs.

14. A system comprising:
at least one computing device having at least one processor; and
at least one computer readable storage medium having program instructions embodied therewith, the program instructions readable/executable by the at least one processor to cause the system to:
identify one or more factors of one or more search result candidates;
generate a data structure that associates a plurality of decision trees with a range of leaves that have been invalidated for one or more nodes of the plurality of decision trees for at least a first value of the one or more factors; and
score the one or more search result candidates based at least in part on analyzing the data structure.

15. The system of claim 14, wherein the processor further causes the system to generate a first quantity of bitmaps, each of the first quantity of bitmaps including a second quantity of records that match a quantity of nodes that are set to FALSE within the plurality of decision trees.

16. The system of claim 15, wherein the processor further causes the system to modify a set of bits of the bitmaps to a value of 0 indicating which leaves of each tree of the plurality of decision trees is not reachable based on a first bit value to read 1.

17. The system of claim 14, wherein the processor further causes the system to analyze a first structure that lists each factor of a decision tree forest, the structure including a first pointer that maps a first factor of the one or more factors to a largest value in a range of values associated with the first factor, the first structure includes a second pointer that maps the first factor to a portion of the data structure that corresponds with the associating the plurality of decision trees with the range of leaves.

18. The system of claim 14, wherein the processor further causes the system to analyze a first structure that lists a plurality of factors and each value associated with the plurality of factors, wherein the first structure includes a pointer that maps a first value of a first factor of the one or more factors to a portion of the data structure that corresponds with the associating the plurality of decision trees with the range of leaves.

19. The system of claim 14, wherein the processor further causes the system to further comprising identifying, within a modified set of bitmaps, a first K position bit that indicates that a leaf is reachable, wherein the scoring of the one or more search result candidates is further based on the identifying of the first K position.

20. The system of claim 19, wherein the one or more decision trees are Gradient Descent Boost Trees (GDBT), and wherein the identifying of the first K position bit occurs in response to analyzing each false node of the one or more decision trees and further in response to the generating of the data structure.
